(19) United States
(12) Patent Application Publication
(10) Pub. No.: US 2004/0068739 A1
(43) Pub. Date: Apr. 8, 2004

(54) Networked multimedia system having a multi-room interactive network guide

(76) Inventors: Samuel H. Russ, Lawrenceville, GA (US); Michael A. Gaul, Lawrenceville, GA (US); John M. Schlarb, Duluth, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/403,485

(22) Filed: Mar. 31, 2003

Related U.S. Application Data
(60) Provisional application No. 60/416,155, filed on Oct. 4, 2002.

(51) Int. Cl. H04N 7/18; G06F 13/00; H04N 5/445; G06F 3/00

(52) U.S. Cl. 725/39; 725/38; 725/48

(57) ABSTRACT

Systems and methods are disclosed for providing downstream signals to a plurality of receiver networks. A receiver network (i.e., a networked multimedia system) includes a splitter/isolation module (SIM), a primary set-top terminal (STT), and at least one remote device. The remote devices communicate with the primary STT via the SIM over coaxial cable. Accordingly, the remote devices utilize some or all of the features including hardware and software that are included in the primary STT via the networked multimedia system. A network guide is provided that displays the past and present activity status of each of the receiving devices.

### CROSS-REFERENCE TO RELATED PATENT APPLICATIONS

The present application claims priority to U.S. provisional application having serial No. 60/416,155 filed on Oct. 4, 2002; also, the present invention is related to U.S. patent application Ser. No. 10/212,017, which was filed on Aug. 2, 2002, and U.S. patent application Ser. No. 10/235,201, which was filed on Sep. 5, 2002, the disclosure and teachings of which are hereby incorporated by reference. Furthermore, the present application incorporates by reference in its entirety herein copending U.S. patent applications having Ser. Nos. 10/263,160, 10/263,449, and 10/263,270, which were filed on Oct. 2, 2002 and are assigned to a common assignee, the disclosure and teachings of which are hereby incorporated by reference.

### FIELD OF THE INVENTION

This invention relates in general to broadband communications systems, and more particularly, to the field of a network multimedia system having receiving terminals and a multi-room interactive network guide that is suitable for use in the broadband communications system.

### DESCRIPTION OF THE RELATED ART

Broadband communications systems, such as satellite and cable television systems, are now capable of providing many services in addition to analog broadcast video. In implementing enhanced programming, the set-top terminal (STT), otherwise known as the set-top box, has become an important computing device for accessing various video services. In addition to supporting traditional analog broadcast video functionality, many STTs now also provide other functionality, such as, for example, an interactive program guide (IPG), video-on-demand (VOD), subscription video-on-demand (SVOD) and functionality traditionally associated with a conventional computer, such as e-mail. Recently new functionality has been added to conventional STTs—namely the ability to record an incoming video stream in digitized form onto a mass storage device, such as a hard disk drive, and play back that recorded video as desired by the user. This functionality has become known as a “digital video recorder” (DVR) or personal video recorder (PVR) and is viewed as a superior alternative to conventional video tape recorders for capture and subsequent playback of programming content.

An STT is typically connected to a communications network (e.g., a cable or satellite television network) and includes hardware and software necessary to provide various services and functionality. Preferably, some of the software executed by an STT is downloaded and/or updated via the communications network. Each STT also typically includes a processor, communication components, and memory, and is connected to a television or other display device. While many conventional STTs are stand-alone devices that are externally connected to a television, an STT and/or its functionality may be integrated into a television or other device, as will be appreciated by those of ordinary skill in the art.

An STT is typically connected to a television set and located at the home of the cable or satellite system subscriber. Since the STT is located at a subscriber's premises, it typically may be used by two or more users (e.g., household members). Television has become so prevalent in the United States, however, that the typical household may have two or more television sets, each television set requiring its own STT if the subscriber wishes to have access to enhanced functionality. However, STTs can be expensive and users may not be willing to purchase additional expensive STTs. This is particularly true of STTs incorporating PVR functionality since such devices require not only the addition of a hard disk drive but also additional processing components and software.

Therefore, there exists a need for systems and methods for addressing these and/or other problems associated with STTs. Specifically, there exists a need for systems and methods that allow multiple users operating discrete STTs within a networked premises or other local area to have access to programming and content received by and/or stored in another STT. Moreover, there also exists a need for the ability to control and/or monitor the discrete STTs within the networked premises.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a simplified block diagram depicting a non-limiting example of a conventional broadband communications system.

FIG. 2 is a block diagram illustrating one preferred embodiment of a networked multimedia system (NMS) that is suitable for use in the broadband communications system of FIG. 1.

FIG. 3 is a simplified diagram of one preferred embodiment of a remote set-top terminal (STT) device that is suitable for use in the NMS of FIG. 2.

FIG. 4 depicts a non-limiting example of a recorded programs list screen that may be presented to a remote device of FIG. 3 via the NMS of FIG. 2.

FIG. 5 is a table illustrating a stored presentation and its program identifier (PID) value and the presentation's remapped PID value prior to transmission.

FIG. 6 illustrates a non-limiting example of one preferred embodiment of an interactive program guide (IPG), which is suitable for use in the NMS of FIG. 2.

FIG. 7 illustrates the IPG of FIG. 6 further including functionality listings, such as a personal video recording (PVR) recorded list and the network guide (NG), among others.

FIG. 8 illustrates a network guide screen in accordance with the present invention, which is suitable for use in the networked system of FIG. 2.

FIG. 9 illustrates a non-limiting screen that displays a customize network guide screen 900.

FIG. 10 illustrates a non-limiting screen that displays all of the receiving devices that are in the networked system of FIG. 2.

FIG. 11 illustrates a non-limiting example of a name entry screen that may be presented to a user after the user selects the highlighted listing of FIG. 10.

FIG. 12 illustrates a non-limiting example of a personal identification number (PIN) entry screen that is suitable for use in the network guide of FIG. 8.

FIG. 13 illustrates a non-limiting example of a PIN select screen that is suitable for use in the network guide of FIG. 8.

FIG. 14 illustrates a non-limiting example of a filter options screen that is suitable for use in the network guide of FIG. 8.

FIG. 15 is a non-limiting example of a channel number filter options screen that is suitable for use with the filter options screen of FIG. 14.

### DETAILED DESCRIPTION OF THE PREFERRED EMBODIMENTS

Preferred embodiments of the invention can be understood in the context of a broadband communications system and a local network system. Note, however, that the invention may be embodied in many different forms and should not be construed as limited to the embodiments set forth herein. For example, transmitted broadband signals may include at least one of video/audio, telephony, data, or Internet Protocol (IP) signals, to name but a few. Furthermore, receiving devices included in the local network system receiving the transmitted broadband signals may include a set-top terminal (STT), a television, a computer, a personal digital assistant (PDA), or other device. Moreover, in accordance with the present invention a multi-room interactive network guide can have various features, functions, and presentations when displayed. All examples given herein, therefore, are intended to be non-limiting and are provided in order to help clarify the description of the invention.

The present invention is directed towards a multi-room interactive network guide that is suitable for use with a plurality of receiving devices in a networked multimedia system. Briefly, the network guide is an interactive program residing on a primary device, or set-top terminal (STT), and/or on at least one networked remote device within the networked system. The network guide in accordance with the present invention allows a user to, for example, monitor the activities of a plurality of networked devices and/or control the viewing choices of the networked devices, among other examples.

A networked multimedia system (NMS) is described in copending U.S. patent application Ser. No. 10/342,670, filed Jan. 15, 2003, the disclosure and teachings of which are hereby incorporated by reference. As taught therein, the NMS is typically located within a subscriber's premises. It will be appreciated, however, that the NMS can also be used in a multi-unit dwelling, business, school, hotel, or hospital, among others. Advantageously, the NMS allows a plurality of receiving devices in the premises to be locally networked (i.e., home-networked). One of the receiving devices typically acts as the server or primary device (i.e., the primary set-top terminal (STT)) in the NMS. The primary STT receives and forwards upon request broadband multimedia presentations (e.g., analog or digital television channels (i.e., audio/video signals), IP signals, video-on-demand (VOD) signals, administrative signals, etc.) throughout the local network to the plurality of remote devices (i.e., client devices). Furthermore, the remote devices are each capable of requesting and seamlessly receiving from the primary STT resident presentations, such as a stored or recorded presentation, the interactive program guide, or the network guide, for example. Additionally, the remote devices may independently receive presentations from and send upstream signals to the communications network. Accordingly, the remote devices may be simplified, less-costly versions of the primary STT but are capable of utilizing, via the NMS, some or all of the advanced hardware and software features, such as memory, a mass storage device, software applications, or infrastructure for transmitting signals back to the headend, that are available in the primary STT.

In accordance with the present invention, the interactive network guide gathers and displays any activity information as well as, upon user input, controls portions of the viewing choices of the networked remote devices. Notably, parental monitoring is one important feature of the network guide. By way of example, each remote device's current presentation information is retrieved and subsequently displayed on the network guide. For example, the name and/or address of each remote device along with the channel number (i.e., the tuned frequency) and the presentation name can be displayed on, for example, a television, which is coupled to the primary STT. Moreover, another feature relating to parental monitoring may be to control the access to recorded presentations or available television channels by each of the networked remote devices. By way of example, some recorded presentations may not be made available to all of the remote devices depending upon their predominant user. More specifically, if a parent wishes to block the viewing of a particular recorded presentation, in other words, preventing the presentation from being viewed by any one or all of the networked remote devices, the network guide is used to code and subsequently filter the recorded presentation accordingly. Alternatively, a user utilizing any remote device may be required to enter a personal identification number (PIN) prior to viewing certain presentations. A further feature of the present invention includes the ability to concurrently view a single recorded presentation by a plurality of remote devices and/or a viewing device that is coupled to the primary STT. Notably, in accordance with the present invention the single recorded presentation, which is stored on the primary STT, can be transmitted multiple times, and can either be synchronous or asynchronous transmissions of the presentation, to each of the remote devices that wish to view the recorded presentation.

An Example of a Broadband Communications System

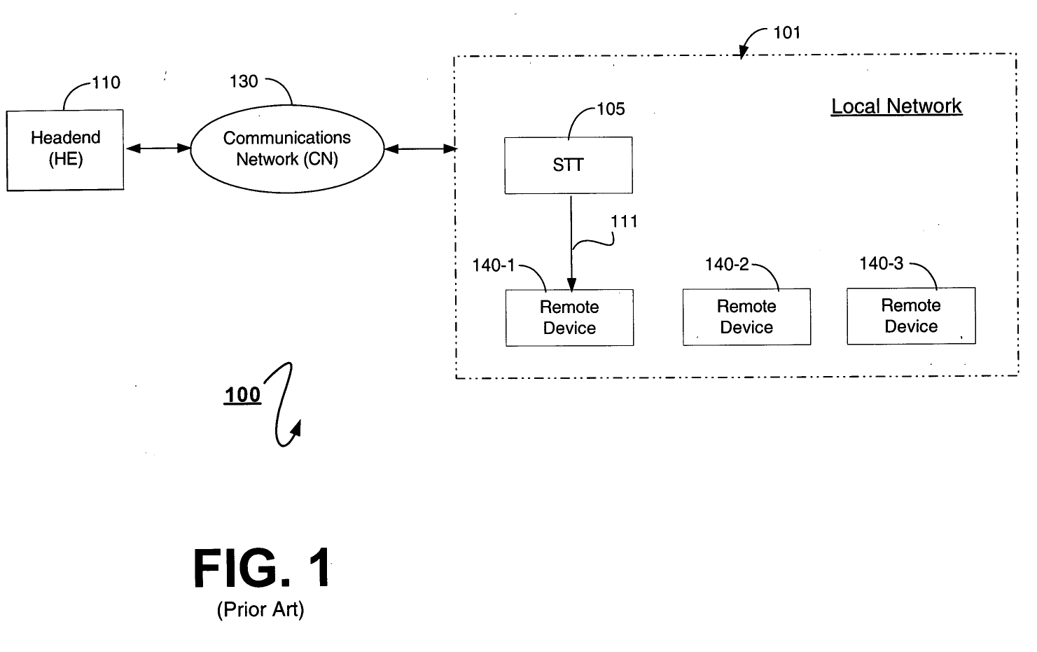

FIG. 1 is a simplified block diagram depicting a non-limiting example of a conventional broadband communications system 100. In this example, the communications system 100 includes a headend 110 that is coupled to a local network (LN) 101 via a communications network (CN) 130. The CN 130 may be any network that is suitable for carrying, preferably downstream and upstream, broadband multimedia signals, such as audio/video signals, IP signals, telephony signals, or data signals to name but a few. The CN 130 may be, for example, a hybrid fiber/coax (HFC) network, a fiber-to-the-home (FTTH) network, a satellite network, or a fixed wireless network (e.g., MMDS), among others.

The headend 110 may include one or more server devices (not shown) for providing broadband signals, such as video, audio, and/or data signals, to the STT 105 via the CN 130. The headend 110 and the STT 105 cooperate to provide a user with a variety of services. The services may include, for example, analog or digital broadcast television services and channels, video-on-demand (VOD) services, and/or pay-per-view (PPV) services, among others. Each broadcast television channel typically provides a sequence of television presentations corresponding to a television station (e.g., ABC, NBC, CBS, or FNN, to name a few) and is typically identified by a channel number (e.g., channel 2, channel 3, channel 4, etc.) that is available to a user at all times. Additionally, PPV services are typically transmitted to the STT 105 at all times, but can only be viewed on the STT 105 as provisioned. On the other hand, the STT 105 typically requests a VOD service and, subsequently, the headend 110 transmits the presentation downstream to the STT 105.

The LN 101 includes a set-top terminal (STT) 105 that provides the broadband signals to remote devices 140-1 and 140-2, and, optionally, to additional remote devices including, for example, remote device 140-3. The STT 105 may be coupled to the remote devices either directly or via one or more other devices. It will be appreciated that the STT 105 may be a stand-alone unit or may be integrated into another device, such as, for example, a television or a computer. Additionally, the remote devices may be located in different rooms than where the STT 105 is located. Further information regarding the LN 101 is provided in copending U.S. patent application Ser. Nos. 10/263,160; 10/263,270; and 10/263,449, which were filed on Oct. 2, 2002, the disclosure and teachings of which are hereby incorporated in their entirety by reference.

A Preferred Embodiment of the Networked Multimedia System (NMS) including the Network Guide

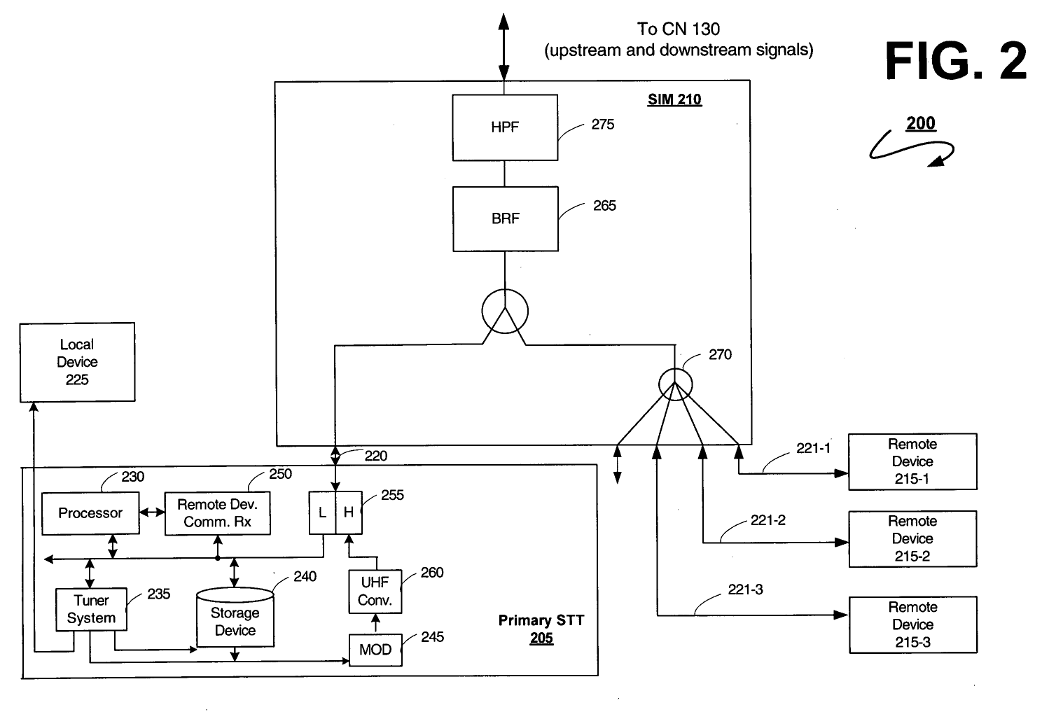

FIG. 2 is a block diagram illustrating one preferred embodiment of the NMS 200 that is suitable for use in the broadband communications system of FIG. 1. The NMS 200 includes a primary STT 205, a splitter/isolator module (SIM) 210, and a plurality of remote devices 215-n. Briefly, the SIM 210 receives downstream broadband signals from, for example, a headend or satellite and subsequently provides the downstream signals to the primary STT 205 or to both the primary STT 205 and any one or all of the plurality of remote devices 215-n depending on the implementation. Upon command from at least one of the remote devices 215-n, the primary STT 205 may also forward selected real-time downstream signals and/or stored content signals to the requesting remote device(s) 215-n via the SIM 210. More specifically, the plurality of remote devices 215-n communicates with the primary STT 205 by sending reverse control/command signals via coaxial cable 220, 221-n requesting, for example, stored presentations, real-time signals, or the network guide. It will be appreciated that other wired mediums, such as telephone lines or data cables, may be used so long as the transport format accommodates the desired transmission medium. Advantageously, in accordance with the present invention, the plurality of remote devices 215-n have access to all of the primary STT's hardware and software functionality, along with receiving downstream signals directly from the headend via the SIM 210. In this manner, the remote devices 215-n may have limited resources, such as not including a storage device in order to record and store a presentation, thereby decreasing the overall costs to the service provider and the subscriber while offering advanced services to all of the remote devices that are networked to the primary STT 205.

Furthermore, the primary STT 205 may also directly provide signals, such as analog and digital channels, stored presentations, or the network guide to name but a few, to a coupled local device 225, which may be, for example, a television, computer, or PDA (personal digital assistant), among others. It will be appreciated that the primary STT 205 may transmit signals to and receive control signals from the local device 225 via wireless devices (e.g., RF or IR devices) or a wired medium (e.g., coaxial cable, power lines, or telephone lines). It will also be appreciated that the primary STT 205 may be incorporated in the local device 225.

FIG. 2 also illustrates a simplified, non-limiting block diagram of selected components of the primary STT 205 in accordance with one preferred embodiment of the present invention. In other embodiments, a primary STT 205 may include only some of the components shown in FIG. 2, in addition to other components that are not shown. Importantly, however, the primary STT 205 includes a processor 230, a tuner system 235, a storage device 240, a modulator 245, and a remote device communications receiver 250. In operation, downstream signals (i.e., signals typically ranging from 45 MHz to 850 MHz) are transmitted via the SIM 210 to a low pass filter in diplex filter 255, which provides the downstream signals to the tuner system 235. A plurality of tuners (not shown) included in the tuner system 235 are used to tune to frequency ranges that include content signals indicative of presentations, such as an analog or digital television channel, a PPV event, a VOD presentation, etc. For example, a VOD presentation may, in response to a user request, be received from the headend in the frequency range around 755 MHz, which corresponds to a particular television channel, such as channel 210. The user, therefore, selects the television channel 210 and, in response, a tuner in the tuner system 235 tunes to the frequency range around 755 MHz and extracts the received VOD presentation's content signals. Depending upon the implementation, the tuned VOD presentation is then provided to the local device 225 for viewing, the storage device 240 for storing, and/or the modulator 245 for modulating and subsequent transmission to the plurality of remote devices 215-n.

In the event that a remote device 215-n, upon user input, requests a presentation, a reverse command signal is transmitted from the remote device 215-n to the primary STT 205 via the SIM 210. The remote device command receiver 250 receives and demodulates the command signal according to its transmission method, such as frequency-shift keying (FSK) or on-off keying (OOK) transmission. The processor 230 subsequently receives the demodulated command signals indicative of the requested action (e.g., requesting a presentation) and in accordance therewith instructs the tuner 235 to tune to, for example, a channel carrying a real-time downstream signal, or the processor may retrieve a stored presentation from the storage device 240. The presentation's content signals are then provided to the modulator 245, which modulates the selected presentation prior to forwarding to the SIM 210. A preferred embodiment of the present invention uses a quadrature amplitude modulation (QAM) modulator, which may be used for effectively transmitting signals over coaxial cable in a cable television environment. Other embodiments may include a quadrature phase-shift keying (QPSK) modulator in a satellite environment, an 8VSB (8-vestigial sideband) modulator in a digital terrestrial environment in the U.S., and a COFDM (coded orthogonal frequency division multiplexing) modulator in a digital terrestrial environment in Europe, or alternatively an analog modulator.

The modulated presentation is up-converted to a predetermined higher frequency, which is preferably greater than the highest frequency used in the communications network 130 (FIG. 1), with, for example, a UHF converter 260. In other words, the selected presentation is up-converted to a high frequency channel, such as channel 134, which may have a frequency range from 852 MHz to 858 MHz. It will be appreciated that other frequency ranges can be used, however, so long as the predetermined frequency is within the range that is tunable by the plurality of remote devices 215-n. In this example, the service provider would provide downstream signals in the range from 45 MHz to approximately 840 MHz. Accordingly, the up-converted signals at around 855 MHz would not interfere with the downstream signals that are concurrently provided via the common coax 220, 221-n to the primary STT 205 and the remote devices 215-n. The up-converted presentation is subsequently provided to the SIM 210 via a high pass filter in the diplex filter 255.

Furthermore, FIG. 2 illustrates a block diagram of a SIM 210 that comprises passive splitter/isolation components in accordance with the present invention. More specifically, a band reject filter (BRF) 265 rejects the frequencies (e.g., from 852 MHz to 858 MHz) of the selected NMS presentation, thereby not allowing the presentation to leave the NMS 200 and enter the communications network 130. It will be appreciated, therefore, that the NMS presentation is reflected off the BRF 265 and routed to a splitter 270 for transmission to the plurality of remote devices 215-n. A high pass filter (HPF) 275 is included to ensure that the reverse command signals provided by the plurality of remote devices 215-n are reflected and routed to the primary STT 205 and similarly not transmitted to the communications network 130. It will be appreciated that if there are significant internal power losses, an amplifier (not shown) can also be included to amplify the downstream signals as necessary.

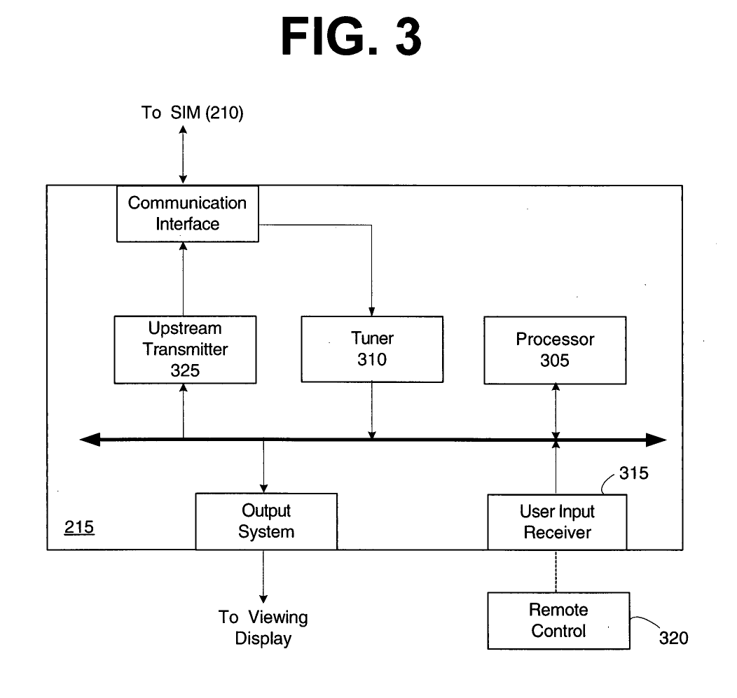

FIG. 3 is a simplified diagram of one preferred embodiment of a remote STT device 215-n that is suitable for use in the NMS of FIG. 2. It will be appreciated that the remote device 215-n may be identical to the primary STT 205 and just share the storage device contents of the primary STT 205. Alternatively, the remote devices 215-n may be a simplified or conventional version of the primary STT 205. A processor 305 and a tuner system 310, which may be a simplified processor and only one tuner, may be included to extract channels from the received downstream broadband signals. Additionally, decryptors and decoders (not shown) may be included to decode encoded signals for proper processing and display. Preferably, the remote devices 215-n include a user input receiver 315, such as an IR receiver or an RF receiver, that receives signals from a remote control 320, such as an IR remote control or an RF remote control. It will be appreciated that the remote control 320 is not required, and any user input device could be incorporated in the remote devices 215-n.

The reverse command signals, which typically originate from user input commands (e.g., tuned channels, NMS functions, IPG display, etc.), are transmitted via the coaxial cable 221-n that are routed between the remote devices 215-n and the SIM 210. It will be appreciated that though the coaxial cables 221-n are shown as separate cables, a common coaxial cable can be used tying the remote devices 215-n together so long as the processor 305 of each networked remote device 215-n is configured to understand and reject other remote device's reverse command signals. A preferred embodiment of the present invention processes and transmits the reverse command signals that are indicative of user input commands using frequency shift keying (FSK) and utilizes existing components that are typically included in a conventional remote set-top terminal. More specifically, a QPSK modulator (not shown) is typically included in the upstream transmitter 325 for modulating conventional upstream signals, which are signals typically ranging from 5 MHz to 40 MHz, for transmission to the headend and, in accordance with the present invention, for modulating the reverse command signals, which are signals typically at a frequency around 2.5 MHz, that are routed throughout the NMS 200. Accordingly, the QPSK modulator has an adjustable tuning frequency that accommodates both of the reverse command signals and the upstream signals. In this manner, the reverse command signals do not interfere with conventionally transmitted upstream signals that may be provided by the remote devices 215-n. According to the preferred embodiment, the remote device command receiver 250 includes an FSK demodulator for demodulation. It will be appreciated, however, that the reverse command signals may alternatively be transmitted using, for example, on-off keying (OOK) or any other serial data transmissions, and the command receiver 250 can include any demodulator that is in accordance with the reverse command signal transmission used. After demodulation, the command receiver 250 sends signals indicative of the reverse command signal, such as, for example, requesting a recorded programs list, to the processor 230 for processing accordingly.

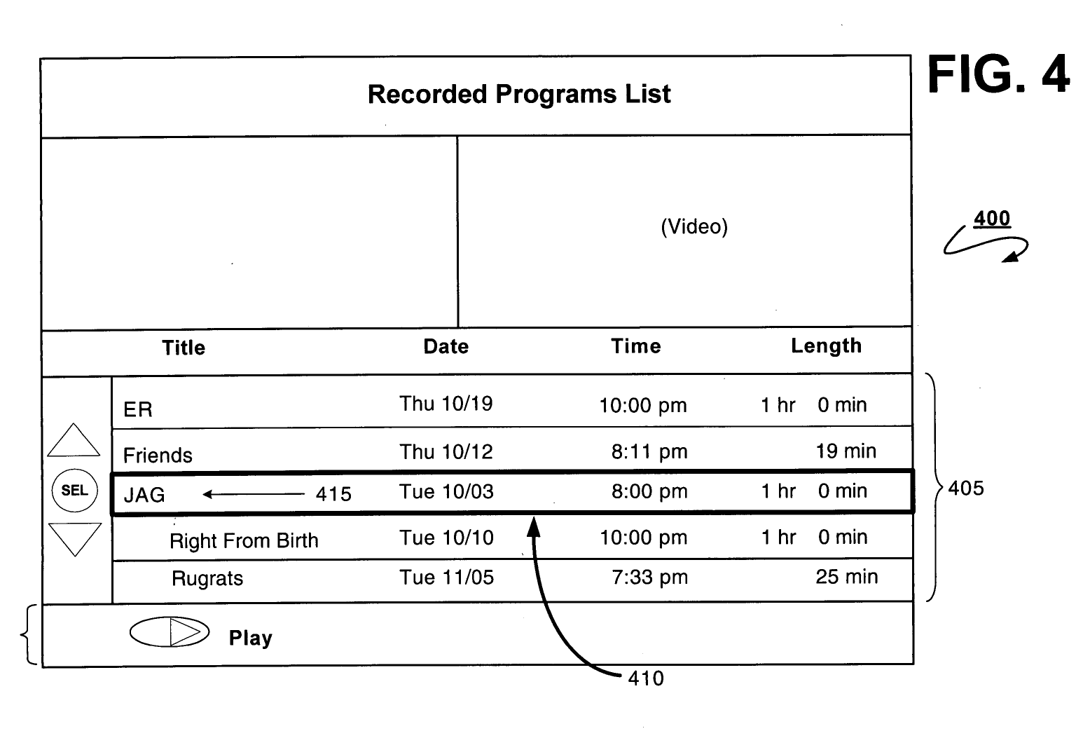

FIG. 4 depicts a non-limiting example of a screen showing a portion of the recorded programs list that may be presented to the plurality of remote devices 215-n via the NMS 200 of FIG. 2. By way of example, when a remote device 215-n requests a list of the recorded programs (i.e., presentations stored in the storage device 240), the processor 230 accesses the recorded programs list 400, which is stored in memory (not shown), and subsequently forwards the content signals indicative of the list 400 to the modulator 245 for modulation and transmission to the requesting remote device 215-n. The recorded programs list 400 displays a list including all the recorded programs 405 showing, for example, the title, the recording date and time, and the length of the program. A presentation in the highlighted program line 410 can typically be selected for viewing by pressing a select button or a play button on a remote control. For example, a presentation entitled JAG 415 was recorded on Tuesday, October 3 and is one hour in length. After the user selects the presentation, the remote device 215-n sends a reverse command signal that is indicative of the selected presentation (i.e., JAG 415) to the remote command receiver 250 via the SIM 210. Accordingly, the processor 230 extracts the JAG presentation from the storage device 240 using an identifier, which will be discussed below. The presentation is subsequently modulated and transmitted to the SIM 210 for delivery to the remote device 215-n. The requesting remote device 215-n tunes to the modulator frequency and waits for the response (i.e., the JAG presentation 415).

The presentations stored in the storage device 240 include program identifiers (PIDs), which may be indexed and stored as a table in the primary STT's memory (not shown). The PIDs also remain in a portion of the header information that is included with the presentation. Those skilled in the art understand that a quadrature amplitude modulation (QAM) stream, such as the modulation stream at the output of the headend 110 (FIG. 1), can combine multiple presentations and television channels, for example, and each presentation has an identifying PIDs to ensure their proper routing. Presentations stored in the storage device 240 are subsequently stored along with their associated PIDs. The processor 230 identifies the presentation and its PIDs, and then as is known to one skilled in the art accesses the presentation from the storage device 240. Prior to providing the presentation to the modulator 245, however, the processor 230 remaps the PID values in accordance with the present invention.

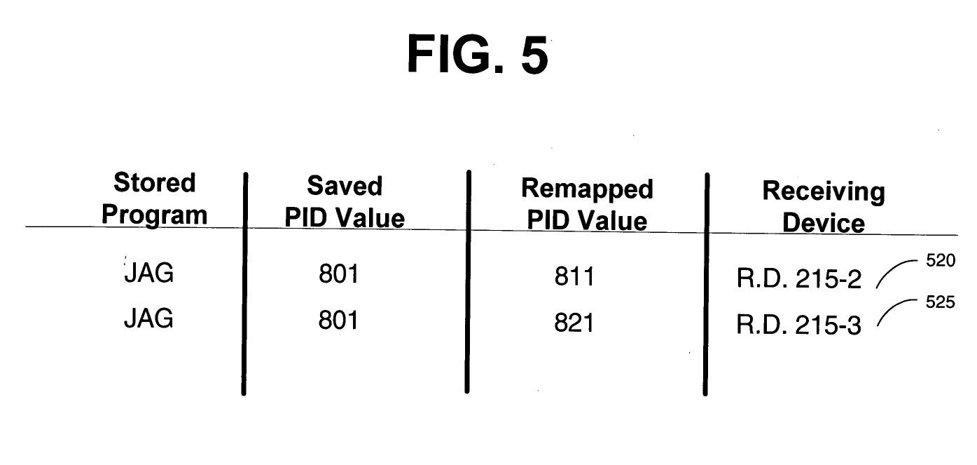

FIG. 5 is a table illustrating a stored presentation 505 having a saved PID value 510 and the presentation's remapped PID value 515 prior to the processor 230 routing the presentation to the modulator 245. As is known to one skilled in the art, PID remapping comprises replacing the PID in the header of the packet with a different value to prevent conflicting PIDs and/or two or more packets from having the same PID value in the header. PID remapping may be accomplished by a variety of methods, such as, for example and without limitation, by use of a table, by an algorithm, or by hardware. In accordance with the present invention, PID remapping is used on stored presentations prior to sending the presentations to the remote devices 215-n so that no two presentations are provided with the same PID value. Accordingly, a plurality of networked receiving devices 225, 215-n may watch a single stored presentation by remapping the PID value 510 of the stored program to a different PID value 515 prior to modulation. For example, remote device 215-2 may be receiving the stored presentation JAG that is being transmitted under remapped PID 811 (line 520). If remote device 215-3 would also like to receive the stored presentation JAG, the remote device 215-3 sends the respective command signal, and, in response, the stored presentation JAG may be transmitted under, for example, remapped PID 821 (line 525). In this manner, the single stored program listed having PID value 801 basically remains in the storage device 240, while the transmitted presentation is a copy of the stored presentation having a remapped PID value. The processor 230 alerts the requesting remote devices 215-n of the expected remapped PID value in order to ensure that each remote device 215-n extracts from the signal the requested presentation.

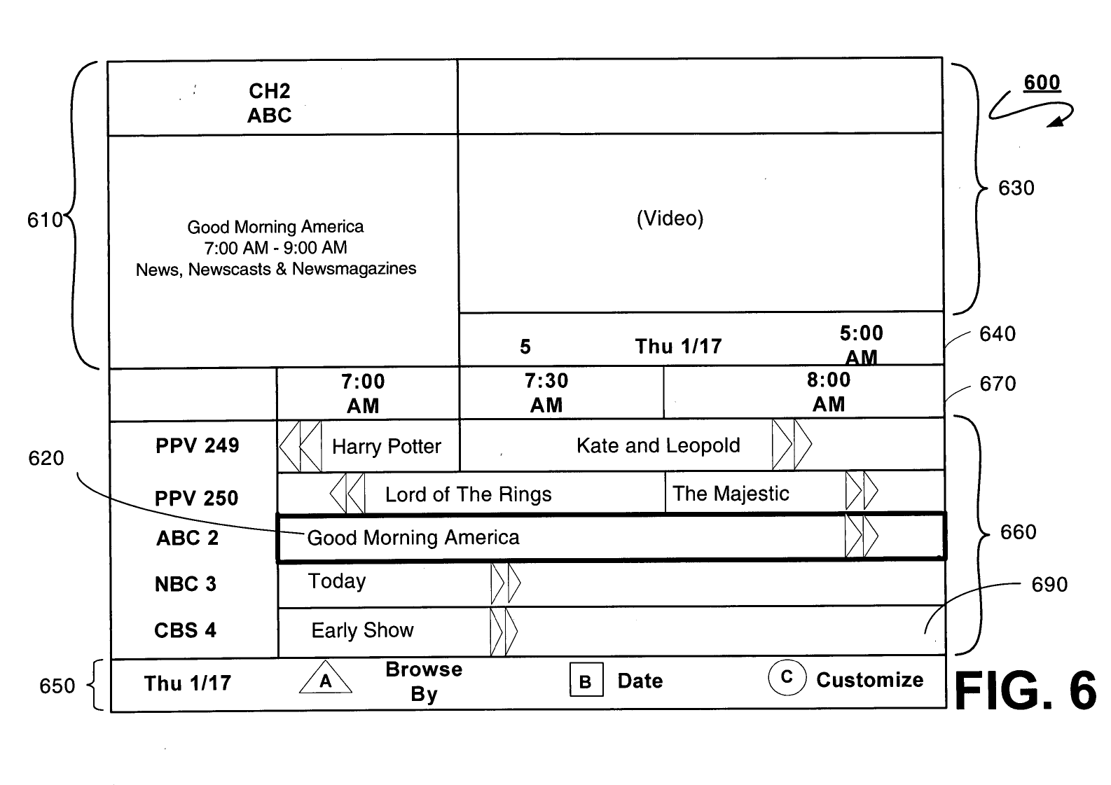

FIG. 6 illustrates a non-limiting example of an interactive program guide (IPG) screen that is suitable for use in the NMS of FIG. 2. The IPG screen 600 may be presented in response to user input that may be provided via, for example, the activation of a guide key on the remote control. The top left portion of the IPG screen 600 is a detailed focus area 610 that includes detailed information for a currently highlighted presentation listing, which in the current example, is the Good Morning America presentation 620. The detailed presentation listing 620 may include channel number, channel number description (e.g., PPV, ABC, NBC, etc.), presentation name (e.g., Good Morning America), duration of the presentation, and/or any episode information or rating. Video corresponding to the channel to which the primary STT 205 is currently tuned may be displayed in a video area 630. Immediately below the video area 630 is an information banner 640 for displaying the channel number corresponding to the channel to which the primary STT 205 is currently tuned (e.g., 5), the current day and date (e.g., Thursday, January 17), and the current time (e.g., 5:00 AM). In one embodiment, arrow buttons on the remote control can be used to scroll through a main presentation listing 660 and to highlight a desired presentation listing. As a user scrolls in time across a calendar day boundary 670, the day and date indications displayed in various areas are updated. The bottom area 650 of the IPG screen 600 indicates the selected day for which presentation listing data is being displayed as well as information about the current functions of the optional “A,” “B,” and “C” keys that may be on the remote controls and are used in conjunction with the IPG. Further information regarding an interactive program guide can be found in copending U.S. patent application Ser. No. 10/212,017 filed on Aug. 2, 2002, the disclosure and teachings of which are hereby incorporated by reference.

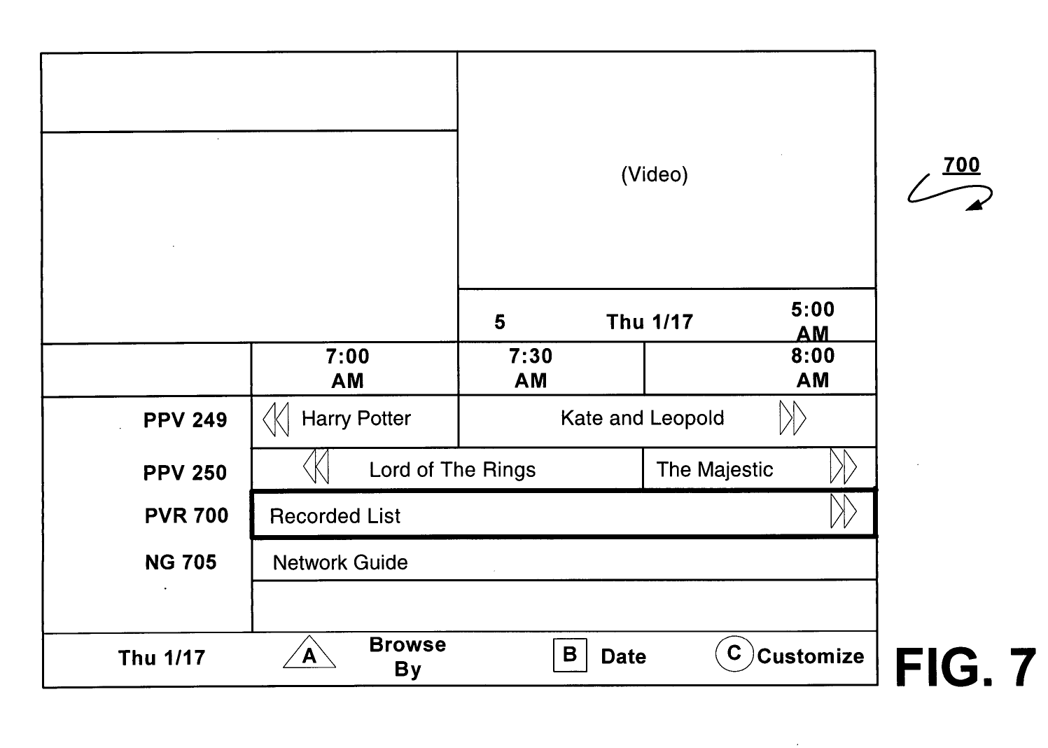

FIG. 7 illustrates the IPG of FIG. 6 further including functionality listings, such as a personal video recording (PVR) list and the network guide (NG), among others. Highlighting and selecting the PVR presentation listing accesses the recorded programs list screen 400 (FIG. 4). Additionally, highlighting and selecting the NG presentation listing accesses the network guide in accordance with the present invention. Alternatively, the user can select the channel number using number keypads on the remote control, such as entering numbers 700 or 705, respectively.

FIG. 8 illustrates a network guide screen in accordance with the present invention that is suitable for use in the networked system of FIG. 2. The network guide 800, as shown, displays the current activity for each of the networked receiving devices 215-n. It will be appreciated that the display typically defaults to on-time information; however, the primary device 205 can easily store in memory the past information of each remote device 215-n, thereby allowing a user to view any past history for a predetermined amount of time. By way of example, the primary device 805, which has been renamed “Family Room,” is currently showing the presentation Lord of the Rings. Similarly, the network guide 800 displays the activity regarding the networked remote devices 215-n. Remote device-1 810, which has been renamed “Kip's Room,” is presently showing the presentation JAG. Additionally, a detailed focus area 815 displays the information regarding the highlighted presentation listing. For example, JAG is a recorded program that was recorded on Tuesday, October 3, and the duration is an hour. There is also no rating (NR) given for this presentation. The remaining networked remote devices, “Josh's Room” and “Master Room,” are currently inactive (e.g., turned off or watching a movie via a connected VCR or DVD player). In this manner, one advantage of the present invention offers an unobtrusive way of parental monitoring.

It can be easily understood that the primary STT 205 inherently knows what presentation each remote device 215-n is currently receiving when the presentations originate from the primary STT 205. By way of example, the processor 230 processes command signals from a remote device 215-n requesting a stored presentation. The processor 230 accesses the presentation from storage and routes the content signals indicative of the presentation to the modulator 245. The modulated presentation is subsequently provided to the remote device 215-n via the SIM 210. Accordingly, the processor 230 updates the network guide 800 with the presentation name and detailed information regarding the presentation along with the requesting remote device name and/or address. Similarly, the primary STT 205 is aware of a tuned presentation (e.g., a television channel or a VOD presentation) that is provided to a remote device 215-n via the tuner system 235 in the primary STT 205.

There are times, however, when a remote device 215-n receives presentations without the assistance of the primary STT 205. For example, a remote device 215-n may tune to a different television channel using its internal tuner system 310 or the remote device may be turned off. Accordingly, in a first embodiment, the primary STT 205 may request an update from the remote devices 215-n in order to update the network guide 800. In which case, the processor 230 in the primary STT 205 sends a request signal to the remote devices 215-n. In response, the remote devices 215-n, via their processor 305, sends reverse command signals to the processor 230 indicating their activity (e.g., presentation name, tuned channel, inactive, etc.). In a second embodiment, the remote devices 215-n may send command signals updating their activity on a regular basis. For example, the remote devices 215-n transmit reverse command signals indicating their activity every five seconds. In a third embodiment, the remote devices 215-n may send command signals only when there is a change in activity (e.g., a channel change, power down, etc.), thereby potentially saving bandwidth. It will be appreciated that in a further embodiment the network guide 800 can be updated by using a combination of all three embodiments.

As described above, the network guide 800 typically resides on the primary STT 205, but it will be appreciated that the network guide 800 can also be accessed from any of the remote devices 215-n depending upon implementation. MPEG encoding may be used to forward the network guide 800 to the networked remote devices 215-n upon request or continuously presented via a broadcast carousel. In accordance with the present invention, the processor 230 digitally encodes the network guide 800 for distribution throughout the NMS 200. The processor 230 outputs the respective compressed video streams and, optionally, audio streams corresponding to the network guide content along with an MPEG packet header. For a non-limiting example, the network guide can be formatted in MPEG-2 or MPEG-1 packetized elementary (PES) streams or transport streams compliant to the syntax and semantics of the ISO MPEG-2 standard, respectively. MPEG as referenced in this application is described in the MPEG-1 and MPEG-2 standards. The MPEG-1 standards (ISO/IEC 11172) and the MPEG-2 standards (ISO/IEC 13818) are described in detail in the International Organization for Standardization document ISO/IEC JTC1/SC29/WG11 N (June 1996 for MPEG-1 and July 1996 for MPEG-2), which is hereby incorporated by reference. Further information regarding a broadcast carousel that is suitable for use with the network guide 800 can be found in copending U.S. patent application Ser. No. 10/235,201 filed on Sep. 5, 2002, the disclosure and teachings of which are hereby incorporated by reference.

It will be appreciated that the user may be given the option of renaming the receiving devices 205, 215-n to any preferred, identifiable name, such as, for example, renaming remote device 215-1 to “Kip's Room” signifying that this device is located in Kip's bedroom. The remote device 215-1 can be renamed from either the primary STT 205 or from any remote device 215-n via the network guide screen 800 by selecting, for example, the “C” on the remote control, which corresponds to the “C” 820 on the guide 800 to customize the network guide 800. It will be appreciated that the buttons may be modified, and the description is intended to be a non-limiting example.

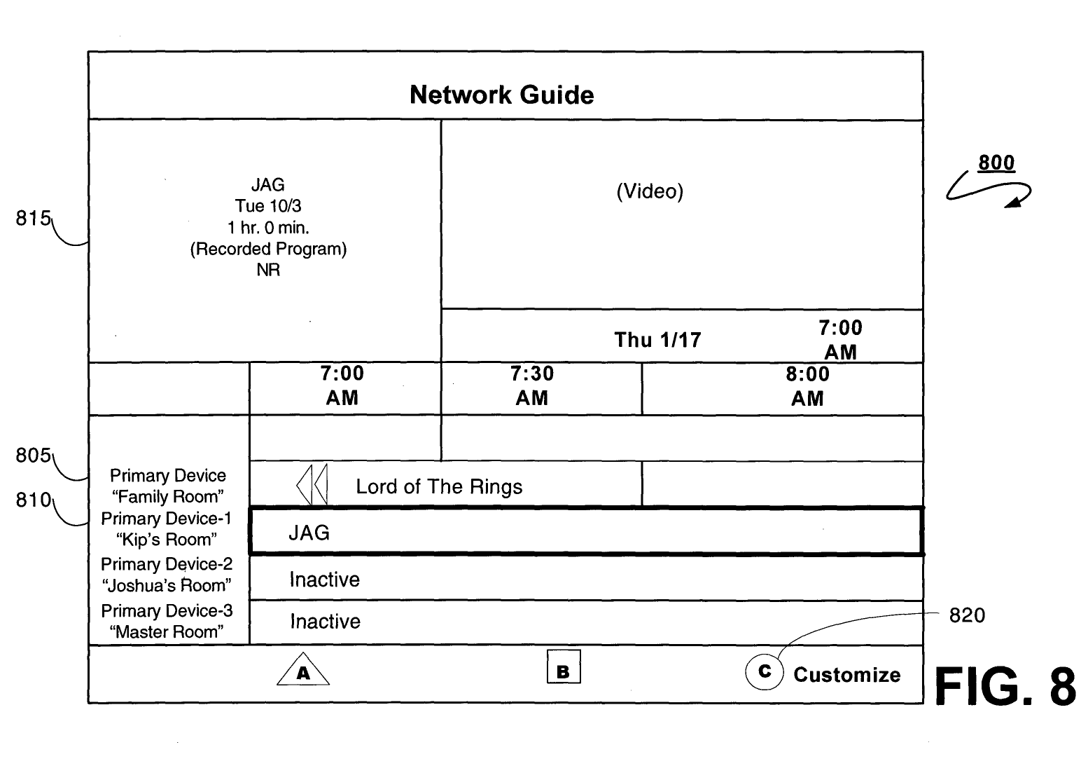

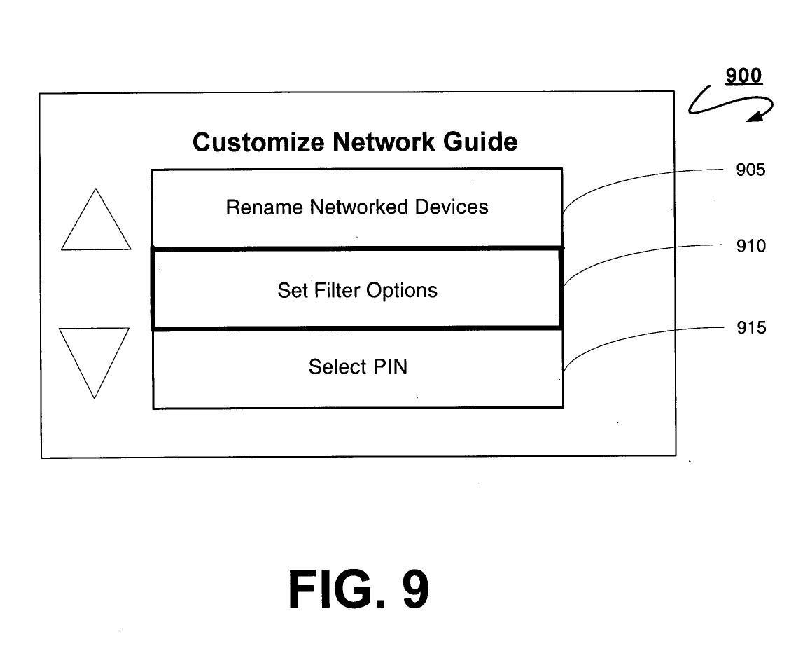

FIG. 9 illustrates a non-limiting screen that displays a customize network guide screen 900. In one embodiment, the customize screen includes the options to rename the networked devices, set filter options, and select a PIN for the network guide 800. By way of example, the user may select the option to rename the network devices 905. After selecting the rename option 905, a screen displaying the networked receiving devices may be displayed. FIG. 10 illustrates the receiving devices 205, 215-n that are in the networked system of FIG. 2. For example, the Family Room and the remote devices 215-1 and 215-2 are shown as being networked in the receiving devices list 1005. A user can select a highlighted listing 1010, which in this case is remote device 215-1, to rename that remote device having a more identifiable name.

FIG. 11 illustrates a non-limiting example of a name entry screen 1100 that may be presented to a user after the user selects to customize the highlighted listing 1010 of FIG. 10. The name entry screen 100 includes name entry fields 1105 that may be used to enter a user name. In one implementation, a user may enter a remote device name by using the left and right arrow keys on the remote control to highlight a desired entry field, and the up and down arrow keys on the remote control to scroll to a desired character in the highlighted entry field. In another implementation, a keyboard may be used to input a remote device name. After the user has entered a desired name, the user may activate, in this case, the “A” key on the remote control to proceed to a subsequent screen.

Referring again to FIG. 9, another option in the customization network guide 900 may be to set filter options 910. In accordance with the present invention, the user may control the viewing choices of the networked receiving devices 205, 215-n by using the filter options. Accordingly, the filter options can be customized to prevent users from not only viewing a blocked presentation, but also from viewing the presentation name and/or channel number. It will be appreciated that there exists methods having a very basic level of filtering and parental blocking, such as customizing a favorites screen that only presents the selected channels in a television guide, or prompting for a user code when the user tunes to a specific television channel that has been blocked; however, the present invention utilizes the NMS 200 and the network guide 800 to further filter and block presentations from any one or all of the networked receiving devices 205, 215-n. Notably, one advantage is that the primary STT 205, for instance, can easily customize all of the networked remote devices 215-n at one time rather than customizing each remote device 215-n separately.

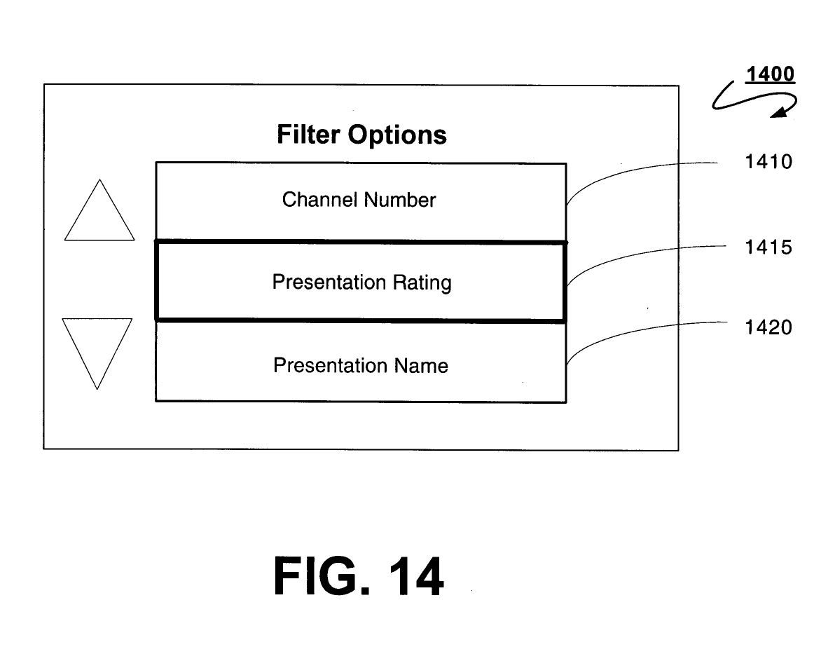

FIG. 14 is a non-limiting example of a filter options screen 1400 that is suitable for use in the network guide of FIG. 8. As illustrated, the user may select the filtering criteria for stored or real-time presentations that are provided via the primary STT 205 based on the channel number, the presentation rating, or the presentation name to name but a few. It will be appreciated that filtering can be accomplished by selecting one or a combination of the filtering options for one or all of the receiving devices 205, 215-n.

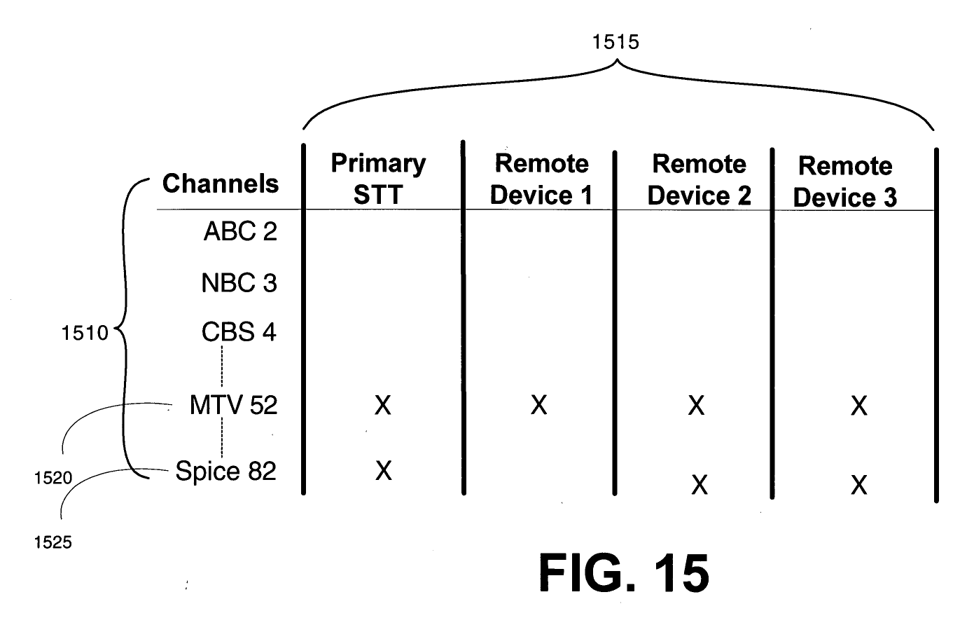

FIG. 15 is a non-limiting example of a channel number filter options screen 1500 that is suitable for use with the filter options screen 1400 of FIG. 14. By way of example, the channel number filter option 1410 filters the television channels that are presented to one or all of the receiving devices 205, 215-n. One embodiment of the present invention is to present the user with a table of the channel numbers 1510 and the networked receiving devices 1515. The user then simply enters an “x” for every channel number at each receiving device that the user wants to block from viewing. For example, the user has blocked the MTV channel 1520 from being presented to every receiving device 1515 in the network 200. Additionally, the Spice channel 1525 is to be blocked from every receiving device 1515 except remote device 1. In this manner, the user easily customizes every receiving device 1515 from one device.

Referring again to FIG. 14, other filtering options may include filtering by presentation rating 1415. For example, the user may select to block presentations, either stored presentations or real-time presentations that are provided via the primary STT 205, that are rated “R” or “TV-MA” from all of the receiving devices except remote device-1, which may be the “Master Room.” Furthermore, the user may filter presentations based on the presentation name 1420 for each receiving device 1515. It will be appreciated that with software adjustments and/or enhancements there may be several ways to filter presentations for the entire network 200. The processor 230 (FIG. 2) receives the updated network guide including the filtering options and updates the primary STT 205. Additionally, the processor 230 distributes the updated network guide to the plurality of remote devices 215-n. The remote devices 215-n in turn update their respective processor 305 (FIG. 3) to include the updated filtering options. The remote devices 215-n, therefore, are preprogrammed to block selected channels and selected presentations based on rating or name.

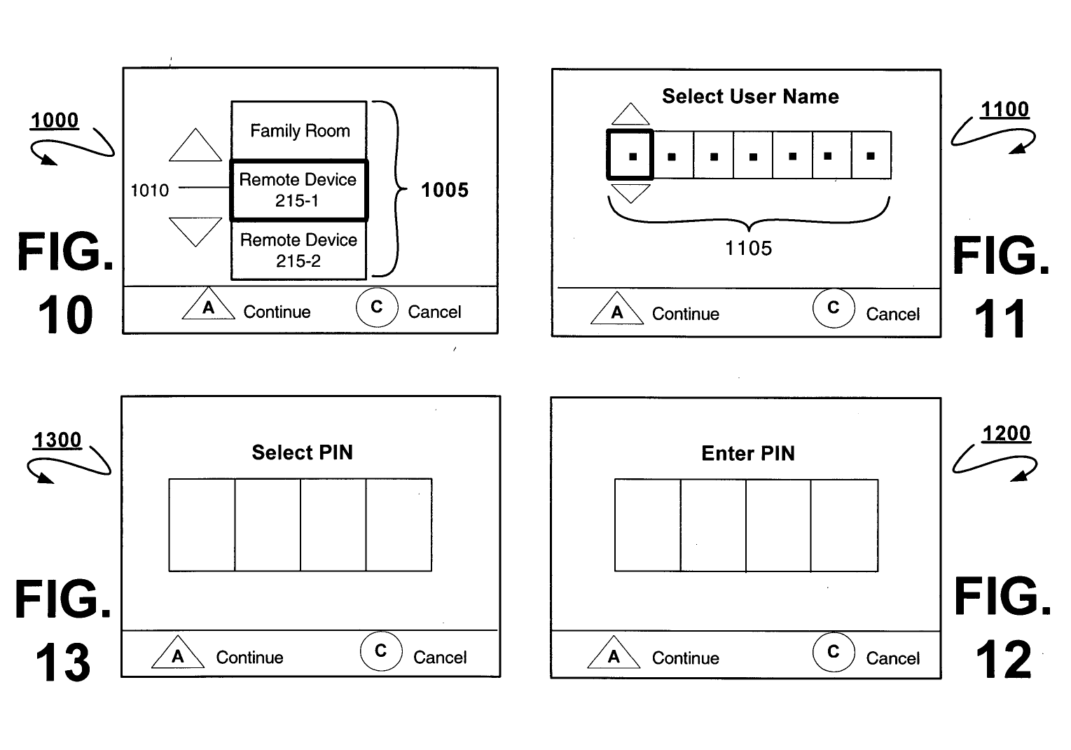

Referring again to FIG. 9, the user can select a personal identification number (PIN) 915 to limit user access to the network guide 800. For example, prior to displaying the network guide information, a PIN entry screen 1200 (FIG. 12) may be presented to the user prompting the user to enter the predetermined PIN. It will be appreciated that the user initially selects the PIN using a non-limiting select PIN screen 1300 (FIG. 13) in a known manner.

As mentioned, the receiving devices can be customized from the primary STT 205 and/or from the remote devices 215-n. When the primary STT 205 customizes the network guide 800 (FIG. 8), the network guide 800 is updated and saved with the new information. The primary STT 205 then broadcasts, either upon request or in a carousel manner, the customized network guide 800 to the remote devices 215-n. Alternatively, the network guide 800 can be customized from any one or each of the remote devices 215-n. In this implementation, the user accesses the network guide 800 and uses the customization screen in FIG. 9 to customize each remote device individually or all of the receiving devices 205, 215-n in the network 200. Once customized, the remote device 215-n transmits the new information via the SIM 210 (FIG. 2) to the primary STT 205 in order to update the network guide 800, which is stored in the primary STT 205. The primary STT 205 then broadcasts, either upon request or in a broadcast carousel, the customized network guide 800 including, for example, renamed remote device(s) 215-n, to the plurality of remote devices 215-n.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the preferred embodiments of the invention in logic embodied in hardware and/or software-configured mediums.

What is claimed is:

1. In a networked multimedia system (NMS) for receiving a plurality of presentations from a communications network, the NMS comprising a plurality of receiving devices including a primary device and a plurality of remote devices, a method for providing a network guide relating to the NMS comprising the steps of:
at the primary device,
retrieving information from the plurality of receiving devices, wherein the information is indicative of a presentation; and
providing a user with a network guide including the retrieved information,
wherein the primary device stores the retrieved information in order to provide the network guide with past and present information.

2. The method of claim 1, wherein the retrieved information is further indicative of an inactive status.

3. The method of claim 1, wherein the retrieved information from each of the receiving devices is indicative of one of a tuned signal, a recorded signal, and an activity status.

4. The method of claim 1, further comprising the step of optionally blocking at least one of the plurality of presentations that is available to any of the plurality of receiving devices.

5. The method of claim 4, wherein the blocking step comprises filtering the at least one blocked presentation according to at least one of a channel number, a presentation rating, and a presentation name.

6. The method of claim 1, further comprising the step of:
at the plurality of remote devices,
providing the primary device information by at least one of upon a request from the primary device, after a predetermined amount of time, and upon a change in activity by a receiving device.

7. In a networked multimedia system (NMS) for receiving content signals indicative of presentations from a communications network, the NMS comprising a plurality of receiving devices including a primary device and a plurality of remote devices, the NMS further including a network guide, the network guide comprising:
a network guide screen including a plurality of presentation listings, wherein one of the plurality of presentation listings is associated with one of the plurality of receiving devices; and
a primary device processor for retrieving the plurality of presentation listings from the plurality of receiving devices via at least one of the primary device processor and a processor associated with each of the remote devices, and for providing the plurality of presentation listings to the network guide screen,
wherein the plurality of presentation listings is at least one of a tuned signal, a recorded signal, and an inactive status.

8. The NMS of claim 7, wherein the content signals are provided to each of the plurality of receiving devices via at least one of the primary device and the communications network.

9. The NMS of claim 7, wherein a highlighted presentation listing in the network guide screen displays detailed information regarding a presentation that is associated with the highlighted presentation listing.

10. The NMS of claim 7, the network guide further comprising a customization screen for customizing the network guide, the customization screen comprising:
a filtering options screen for allowing a user to block at least one selected presentation that is presented to at least one of the plurality of receiving devices,
wherein the primary device processor codes the at least one blocked presentation accordingly and updates the network guide, and wherein the primary device processor distributes the updated network guide via the NMS for updating the processor associated with each of the plurality of remote devices.

11. The NMS of claim 10, the filtering options screen comprising:
a channel number filter;
a presentation rating filter; and
a presentation name filter,
wherein the filter options screen is accessed from at least one of the plurality of receiving devices for customizing at least one of the plurality of receiving devices.

12. The NMS of claim 7, wherein the plurality of presentation listings from each of the remote devices is received at the primary device processor by at least one of a request from the primary device processor, a change in activity by a receiving device, and a predetermined amount of time.

13. The NMS of claim 7, wherein the tuned signal is provided to the plurality of remote devices by at least one of a tuner system associated with the primary device and a tuner system associated with each of the plurality of remote devices.

14. The NMS of claim 7, wherein the recorded signal is provided to the plurality of remote devices by a storage device located within the primary device.

15. A networked multimedia system (NMS) for receiving content signals indicative of a plurality of presentations from a communications network, comprising:
a splitter/isolation module (SIM) for receiving the content signals and for providing the content signals; and
a plurality of receiving devices each coupled to the SIM, the plurality of receiving devices including a primary device and a plurality of remote devices, the primary device comprising:
a network guide displaying an activity status associated with each of the plurality of receiving devices; and
a processor for retrieving the activity status from the plurality of receiving devices and for providing the activity status to the network guide,
wherein the activity status is indicative of at least one of a tuned signal, a recorded signal, and an inactive status.

16. The NMS of claim 15, wherein the content signals are provided to each of the plurality of receiving devices via at least one of the primary device and the communications network.

17. The NMS of claim 15, the primary device further comprising a tuner system for providing selected content signals to one of a storage device, a modulator, and a viewing display.

18. The NMS of claim 17, wherein the processor, upon request, accesses the recorded signal from the storage device and provides the recorded signal to the modulator, wherein the modulator modulates the recorded signal and provides the modulated signal to at least one of the plurality of remote devices via the SIM.

19. The NMS of claim 18, wherein subsequent to accessing the recorded signal, the processor remaps a first PID value associated with the recorded signal to a second PID value.

20. The NMS of claim 15, wherein the tuned signal is provided to the plurality of remote devices by at least one of a tuner system associated with the primary device and a tuner system associated with each of the plurality of remote devices.

21. The NMS of claim 15, the network guide comprising a filtering options screen for allowing a user to block at least one of the plurality of presentations that is presented to any of the plurality of receiving devices.

22. The NMS of claim 21, the filtering options screen including filtering options, the filtering options comprising:
a channel number filter;
a presentation rating filter; and
a presentation name filter,
wherein the at least one of the plurality of presentations is filtered using at least one of the filtering options.

23. The NMS of claim 21, wherein the filtering options screen is accessed from at least one of the plurality of receiving devices for blocking the at least one of the plurality of presentations from transmitting to the at least one of the plurality of receiving devices.

24. The NMS of claim 15, wherein the activity status from each of the plurality of receiving devices is received at the processor by at least one of a request from the processor, a change in activity by a receiving device, and a predetermined amount of time.
